(19) United States
(12) Patent Application Publication
(10) Pub. No.: US 2024/0095204 A1
(43) Pub. Date: Mar. 21, 2024

(54) PERIPHERAL ELECTRONIC DEVICE REPRESENTATION VIA UNIFORM TRANSMISSION PROTOCOL

(71) Applicant: Hewlett-Packard Development Company, L.P., Spring, TX (US)

(72) Inventor: Ravi Shankar Subramaniam, Palo Alto, CA (US)

(73) Assignee: Hewlett-Packard Development Company, L.P., Spring, TX (US)

(21) Appl. No.: 18/262,107

(22) PCT Filed: Jan. 28, 2021
(86) PCT No.: PCT/US2021/015372

§ 371 Date: Jul. 19, 2023

(51) Int. Cl. G06F 13/38; G06F 13/10

(52) U.S. Cl. CPC G06F 13/387; G06F 13/102

(57) ABSTRACT

In one example in accordance with the present disclosure, a computing device is described. The computing device includes a configurable logic element. The configurable logic element 1) connects to a number of peripheral electronic devices, with at least one peripheral electronic device having a different native protocol relative to another peripheral electronic device and 2) prepares and packages a number of signals to be transmitted across a uniform transmission protocol. The computing device also includes a communication pathway to transmit packaged signals to a driver using the uniform transmission protocol. The computing device also includes the driver to 1) unpack the number of signals from the aggregated data transmission and 2) represents the number of peripheral electronic devices to an operating system of the computing device.

### BACKGROUND

Computing devices may be coupled to peripheral electronic devices. In one particular example, a peripheral electronic device is a sensor that detects, measures and/or transmits data about a condition. The sensor provides that data to the computing device. For example, cameras, such as visible spectrum cameras, infrared cameras, and thermal imagers may capture images and transmit the images to a display of the computing device. Other examples of sensors include temperature sensors, motion sensors, acoustic sensors, moisture sensors, gyroscopes, and accelerometers, among others. While specific reference is made to particular sensors, computing devices may interact with and collect data from any variety of sensors. Moreover, while particular reference is made to sensors, other peripheral electronic devices such as processors and electronic circuits may be coupled to the computing device.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a computing device for representing peripheral electronic devices via a uniform transmission protocol, according to an example of the principles described herein.

FIG. 2 is a flow chart of a method for representing peripheral electronic devices via a uniform transmission protocol, according to an example of the principles described herein.

FIG. 3 is a block diagram of a computing device for representing peripheral electronic devices, according to an example of the principles described herein.

FIG. 4 is a diagram of a computing device for representing peripheral electronic devices via a uniform transmission protocol, according to an example of the principles described herein.

FIG. 5 is a flow chart of a method for representing peripheral electronic devices, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Computing devices may be coupled to any number of peripheral electronic devices. For example, sensors coupled to a computing device provide the computing device with measured, detected, and/or collected data. As a specific example of a sensor, cameras can capture images and/or video of an environment. Other sensors, such as gyroscopes and accelerometers can measure acceleration rates and orientation of the computing device. Such positional and movement information may be used by the computing device to alter the operation of the computing device. For example, a gyroscope may indicate that a computing device screen has rotated. Responsive to this rotation, the operating system of the computing device may rotate the display of information on the computing device to match the rotation of the device screen. While particular reference is made to a few particular types of sensors, a variety of types of sensors may be coupled to the computing device to provide the computing device with measured or detected data. Other examples of sensors include, visible spectrum cameras, infrared cameras, thermal imagers, temperature sensors, motion sensors, acoustic sensors, moisture sensors, gyroscopes, and accelerometers among others.

Other types of peripheral electronic devices may also be coupled to a computing device. For example, a peripheral electronic device such as a machine learning accelerator or processor, by itself or in combination with a sensor, may be coupled to the computing device. These other electronic devices may provide data to the computing device and/or may filter a signal output from a sensor.

While such peripheral electronic devices undoubtedly provide for enhanced functionality of the computing device based on the information that they provide, integration of these peripheral electronic devices may add to the complexity of the hardware of computing devices and the physical structure of the computing device itself. For example, it may be the case that sensors are connected to a sensor hub of a computing device chipset. A sensor hub may include a micro-controller platform that runs micro-drivers. The micro-drivers process the sensor signals and provide such to the operating system of the computing device. In some examples, a sensor may implement a protocol such as an inter-integrated circuit (I2C) protocol or a serial peripheral interface (SPI) protocol which may have a low bandwidth and transmission rate, thus creating a bottleneck for sensor data transmission.

Moreover, it may be the case that different sensors, or other peripheral electronic devices, have different protocols. That is, for any number of reasons including a target data rate, a target bandwidth, and/or a target cost, a vendor may select a particular protocol for a sensor. That is, there is no uniform protocol for sensor connections. As such, different sensors may have different protocols. For example, an accelerometer may have an I2C connection with the sensor hub while a camera has a mobile industry processor interface/camera serial interface 2 (MIPI/CSI-2) interface or a common programming interface (CPI) connection, while other sensors have any number of other interfaces. As a result, there may be a large quantity of wires passing to and from the sensor hub to the various sensors. This may be particularly cumbersome in regions of a computing device that are geometrically constrained, such as in a hinge of the computing device.

That is, the quantity of wires connecting the various sensors to the sensor hub congests an interior of a computing device. This is particularly prevalent on folding computing devices. For example, on a laptop a sensor may be found in a lid section of the laptop while the sensor hub is found in a base section of the laptop. The wires may therefore run from the lid through a hinge towards the base of the laptop. As such, a hinge of a laptop is constructed to be large enough to accommodate the various wires running through.

Moreover, as the sensor hub includes micro-drivers specific for the sensor, as a new sensor is developed, a new micro-driver or updated micro-drive may need to be developed before the new sensor may be implemented. That is, the micro-drivers are not equipped to keep up with, and adapt to, the development of new sensor types or updates to existing sensors. As a result, sensor integration into a computing device may be limited by the development of an associated micro-driver to accommodate the new sensor type.

Accordingly, the present specification describes devices and methods for addressing these and other issues. Specifically, the computing device includes a field programmable gate array (FPGA) or other configurable logic element. The configurable logic element interfaces to peripheral electronic devices such as sensors or other integrated circuits, chips, or devices like machine learning accelerators, using the sensor native protocol. The signals from these peripheral electronic devices are then packaged onto the peripheral component interconnect express (PCIe) or universal serial bus (USB) protocol. Once the data transmitted via the PCIe or USB protocol is received at an operating system (OS) driver, the OS driver unpacks the signals, and creates an endpoint per each peripheral electronic device. In this example, each endpoint represents the original peripheral electronic device or a virtual representation of a new peripheral device that is derived or enhanced from the original. The OS or application interacts with this representation as if it was the original device.

Note that such communication is bi-directional. That is, because each peripheral electronic device is represented to the OS of the computing device, the OS may interact with that peripheral electronic device to receive data or to send commands. For example, a first application on the computing device may interface with a camera and a second application may interface with a microphone. In this example, the first application may issue a command to change a resolution of the camera and the second application may issue a command to shutdown of the microphone. In this example, both of these commands may be issued at the same time and these commands may be aggregated into a single data transmission and sent to the configurable logic element, where they are disaggregated and presented to the respective peripheral electronic devices for execution.

In summary, the computing device implements a configurable logic element such as an FPGA to interface with peripheral electronic devices such as sensors using their native protocols. Signals from these peripheral electronic devices are aggregated at the data level using circuit logic rather than micro-drivers. The signals are then packaged and transmitted via a PCIe or USB connection directly to an OS driver which may represent the peripheral electronic device to an application executed by a central processing unit (CPU). The OS driver unpacks the signals for access by the operating system. The OS driver therefore represents the respective peripheral electronic devices to the operating system as if each peripheral electronic device had its own driver. Accordingly, the OS and the peripheral electronic devices may interface with one another as intended and the OS may not be aware of the encapsulation, aggregation, and transmission of the signals across the uniform transmission protocol. As such, the present computing device provides a single high-performance protocol (e.g., PCIe or USB) from an aggregation integrated circuit to the CPU of the computing device so as to eliminate a sensor hub and the complex wiring that may be used with such a sensor hub without impacting the operation of the operating system to access and interact with peripheral electronic devices.

In some examples as described below, the configurable logic element may also manage the states of the peripheral electronic devices so as to ensure that the duty cycle of the communication pathway and/or peripheral electronic devices can be adjusted to ensure that the communication pathway spends more time in a lowest power state so as to reduce the energy consumed, which may increase a battery life of the computing device.

Specifically, the present specification describes a computing device. The computing device includes a configurable logic element. The configurable logic element connects to a number of peripheral electronic devices with at least one peripheral electronic device having a different native protocol relative to another peripheral electronic device. The configurable logic element also prepares and packages a number of signals to be transmitted across a uniform transmission protocol. The computing device also includes a communication pathway to transmit packaged signals to a driver using the uniform transmission protocol. A driver of the computing device unpacks the number of signals from an aggregated data transmission and represents the number of peripheral electronic devices to an operating system of the computing device.

The present specification also describes a method. According to the method, a configurable logic element receives a number of signals from a number of peripheral electronic devices. At least one peripheral electronic device has a different native protocol relative to at least one other peripheral electronic device. The configurable logic element also prepares the number of signals to be transmitted across a uniform transmission protocol. The configurable logic element also aggregates the number of signals into the aggregated data transmission and a communication pathway transmits the aggregated data transmission using the uniform transmission protocol. A driver unpacks the number of signals from the aggregated data transmission and represents the number of peripheral electronic devices to an operating system of a computing device.

In another example, the computing device includes a number of peripheral electronic devices, at least one peripheral electronic device having a different native protocol relative to at least one other peripheral electronic device. In this example, the computing device includes a field programmable gate array (FPGA) to package signals from the number of peripheral electronic devices. Specifically, the FPGA performs at least one of encapsulation and translation of signals and aggregates a number of signals into an aggregated data transmission to be communicated via a uniform transmission protocol. A communication pathway transmits the aggregated data transmission to a driver using the uniform transmission protocol and the driver 1) unpacks the number of signals from the aggregated data transmission and 2) represents the number of peripheral electronic devices to an operating system of the computing device.

Such systems and methods 1) reduce the wire count in a computing device, in particular through constrained zones such as through a hinge and around a motherboard; 2) increase the throughput of transmissions between the operating system and the peripheral electronic devices; 3) reduce the transmission count by aggregating signals; 4) are scalable as the configurable logic element may be re-configured when new peripheral electronic devices are added; 5) reduce power consumption via duty cycling to improve battery life; 6) are robust against developments in sensor technology and development of new sensors; and 7) allow for a reduction in the physical size of a computer, for example by reducing a hinge based on the reduced wire count. In other words, the present devices and methods simplify the entire connection and provide a higher speed, higher bandwidth, and robust aggregation connection to the operating system of various sensors. However, it is contemplated that the systems and methods disclosed herein may address other matters and deficiencies in a number of technical areas.

As used in the present specification and the appended claims, the term “configurable logic element” refers to hardware components where the functionality and the operations may be changed at different points in time. In one particular example, the configurable logic element is a field programmable gate array (FPGA). An FPGA refers to a hardware circuit that may be programmed to carry out different logic operations. That is, an FPGA is an integrated circuit where the functionality of the device may be changed. In another example, the configurable logic element may include multiple integrated circuits.

Moreover, as used in the present specification and in the appended claims, the term “communication pathway” may refer to any path between the configurable logic element and the driver. For example, the communication pathway may be a physical bus between the configurable logic element and the driver.

Still further, as used in the present specification and in the appended claims, the term “peripheral electronic device” refers to any variety of components which may be part of, or coupled to the computing device. As a particular example, the peripheral electronic device may be a sensor. In another example, a peripheral electronic device may be another chip or integrated circuit such as a machine learning accelerator or processor. In yet another example, the peripheral electronic device may include a sensor and an additional chip or integrated circuit.

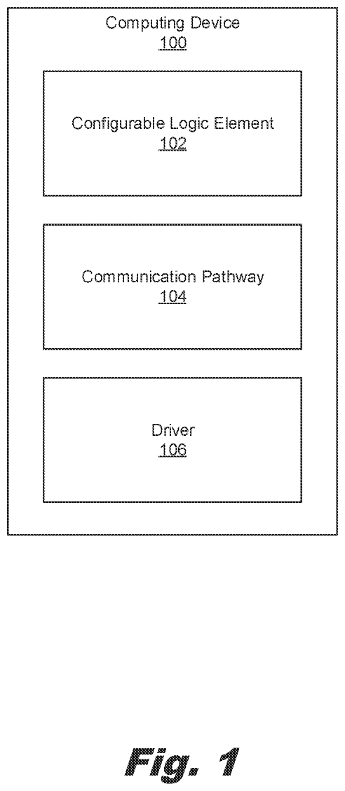

Turning now to the figures, FIG. 1 is a block diagram of a computing device (100) for representing peripheral electronic devices via a uniform transmission protocol, according to an example of the principles described herein. In general, the computing device (100) is coupled to a variety of peripheral electronic devices, each of which may have their own native interface and protocol. In one example, the peripheral electronic devices are disposed on the computing device (100). Such peripheral electronic devices may have native protocols. Examples of native protocols include an I2C and SPI as mentioned above. While particular reference is made to a few native protocols, peripheral electronic devices may implement other native protocols as well.

In some examples, the peripheral electronic devices are separate from the computing device (100). In such a case, the native protocol may be a wireless protocol such as a Wi-Fi protocol or a BLUETOOTH protocol. Similar to the on-device peripheral electronic devices, a signal from a wireless peripheral electronic device may be encapsulated and transmitted to the driver (106). In such an example, the operating system of the computing device (100) may be unaware as to whether the peripheral electronic device is on the computing device (100) or whether the peripheral electronic device is separate from the computing device (100). As such, the driver (106) presents multiple types of peripheral electronic devices with different native protocols to the operating system of the computing device (100) without making the operating system aware of the pathway to the peripheral electronic device.

The computing device (100) includes a configurable logic element (102). The configurable logic element (102) refers to a logic element where the functionality and the operations may be changed at different points in time. In one particular example, the configurable logic element (102) is a field programmable gate array (FPGA). An FPGA refers to a hardware circuit that may be programmed to carry out different logic operations. That is, an FPGA is an integrated circuit where the functionality of the device may be changed.

In another example, the configurable logic element (102) may include multiple devices. In this example, each of the devices may execute a sub-operation of preparing and packaging the number of signals. That is, as described above the configurable logic element (102) may perform a number of operations including encapsulation and/or translation of a signal and aggregation of signals into a data transmission. In the example where the configurable logic element (102) includes multiple devices, each operation may be carried out by a distinct device. For example, a first integrated circuit may translate signals, a second integrated circuit may encapsulate signals, and a third integrated circuit may aggregate signals. Accordingly, the configurable logic element (102) may be an integrated circuit or an integrated set of devices.

The configurable logic element (102) in whatever form, may connect to a number of peripheral electronic devices. At least one peripheral electronic device may have a different native protocol relative to another peripheral electronic device. That is, as described above, a computing device (100) may be connected to a number of peripheral electronic devices, which peripheral electronic devices may be on the computing device (100) or separate from the computing device (100). Each of these peripheral electronic devices may have a different native protocol, such as an I2C, SPI, or wireless protocol for example. Each of these peripheral electronic devices may be connected to the configurable logic element (102) and each may transmit data and receive commands, using its native protocol. For example, a camera may send image data to the configurable logic element (102) using its native protocol and interface.

In addition to sending data, the peripheral electronic device may also transmit control data, which may define the communication between the peripheral electronic device and the computing device (100). For example, the control data for a camera may include configuration data as well as signals/commands to start, stop, pause, and/or change a rate of transmission. While particular reference is made to particular types of control data, a variety of forms of control data may be implemented in accordance with the principles described herein. For example, for a camera, the control data may also include instructions to swivel, pan, tilt or zoom the camera lens. This control data is received at the configurable logic element (102) for each coupled peripheral electronic device.

The configurable logic element (102) prepares and packages a number of signals to be transmitted across a uniform transmission protocol. That is, rather than having multiple wires passing from each peripheral electronic device towards the operating system, the configurable logic element (102) transmits the signals for each peripheral electronic device across a shared communication pathway (104), which communication pathway (104) implements a single, and uniform, transmission protocol for transmitting the various signals to the driver (106).

As described above, the communication pathway (104) may take a variety of forms. In one particular example, the communication pathway (104) is a communication bus. In general, the communication pathway (104) may be point-to-point, shared medium, and may even be wireless. In one particular example, the communication pathway (104) is a PCIe or USB bus.

As described above, the configurable logic element (102) prepares each signal such that it may be sent across the single communication pathway (104). In some examples, the uniform transmission protocol is a peripheral component interconnect express (PCIe) protocol. In another example, the uniform transmission protocol is a universal serial bus (USB) protocol. Either of these protocols provides higher bandwidth and higher transmission speeds than the native protocols used by the peripheral electronic devices. Accordingly, by implementing such high speed and high bandwidth uniform transmission protocols, overall transmission throughput is increased resulting in more efficient data transfer, a greater volume of data transmitted, and reduced power consumption.

Preparing and packaging the number of signals may take a variety of forms. For example, a signal may be encapsulated or translated. Encapsulating a signal includes transmitting the signal in its native protocol, but packaging it within the uniform transmission protocol. In this example, the communication pathway (104) is a container for the signals. That is, the commands and data are in the payload section of the uniform protocol (e.g., PCIe/USB) transmission. Once at the driver (106), the signal is extracted and the peripheral electronic device is presented to the operating system using the native protocol. For example, if an I2C sensor utilizes eight interactions to be configured, then those eight interactions are aggregated into in the PCIe/USB payload and then presented separately by the driver (106). In such an example, the operating system still views the device as a native protocol device.

Translation by comparison, includes converting the signals from native protocol into the uniform transmission protocol (e.g., USB or PCIe) of the communication pathway (104). In this case, the mechanisms used by the uniform transmission protocol are mapped into one or more of the operations that are used in the native protocol.

For example, a protocol may have a header and packet structure. During translation, the configurable logic element (102) converts the header and packet structure of a signal from one protocol to another protocol. Translation may also include changing a format of the signal. Translation may also include a representation change. As a particular example, a native protocol may use 8-bit representation for data while a uniform protocol may use 32-bit representation. In this example, one data item in the uniform protocol may hold 4 data items from the native protocol. In this example, there may be information in the header that indicates that one data item in the uniform protocol holds more than one items of base length 8-bit such that when received at the OS side and vice versa, the proper processing can be applied.

Accordingly, in the example where the uniform transmission protocol is a PCIe or USB protocol, a peripheral electronic device with a translated signal is seen by the operating system as a PCIe or USB peripheral electronic device, and not a peripheral electronic device of its native protocol. In such an example, the native commands and data models are mapped to their PCIe/USB equivalents or some computation done to modify the native commands and data models to the PCIe/USB equivalents. In this example, the peripheral electronic device is represented as a uniform transmission protocol peripheral electronic device and not a peripheral electronic device of its native protocol.

As a specific example with a PCIe communication pathway, the operating system may view a sensor with a translated signal as a PCIe sensor even if the native protocol for the sensor may be the I2C protocol. In some examples, different signals may be encapsulated or translated at different points in time. For example, in some instances a camera signal may be encapsulated and under different circumstances the camera signal may be translated.

In either case, the configurable logic element (102) may also aggregate a number of signals into an aggregated data transmission. In this case, at a given time ‘t’ a first peripheral electronic device and a second peripheral electronic device may have data to transmit. The configurable logic element (102) may read both signals at time ‘t’ and may package them into one USB/PCIe packet to the operating system. Accordingly, the two streams may be said to be aggregated. As a particular example, an accelerometer signal and a gyroscope signal may be received at the same time. Instead of sending them separately, the configurable logic element (102) may aggregate them in an aggregated data transmission. Accordingly, one transmission to the driver (106) may include the multiple sensor signals.

The example presented above represents aggregating multiple discrete signals. In another example, streaming signals may also be aggregated. For example, a camera may continuously stream images at a rate of 30 frames per second to produce a video output on the computing device (100). An accelerometer may also make continuous readings. In this example, these two streams may be combined into a single stream.

As another example, the signals to aggregate may be stereoscopic cameras, each operating at the same frame rate. In this example, instead of creating two streams into the operating system, at 30 frames per second each, the configurable logic element (102) may put both into an aggregated packet stream over a USB/PCIe communication pathway (104) into the operating system at 30 frames per second.

In yet another example, both camera images may be processed and a depth of an object calculated and then a motion of the object may be packaged as a stream over the communication pathway (104). In any of the above scenarios, rather than sending two data transmissions, one for each signal, the communication pathway (104) may send one transmission. This reduces the quantity of transmissions. As each transmission consumes battery power, the reduction in the quantity of transmissions reduces the power consumption and prolongs the battery life of the computing device (100).

As noted above, such packaging may be bi-directional. That is, the configurable logic element (102) may receive an aggregated command signal from the OS. In this example, the configurable logic element (102) unpacks the aggregated command signal and transmits it to the respective peripheral electronic device.

The computing device (100) also includes a driver (106) that unpacks the number of signals from the aggregated data transmission such that the peripheral electronic devices may be represented to an operating system of the computing device (100). In general, a driver (106) is a component that allows the operating system and peripheral electronic devices to communicate with each other. For example, an application may call a function implemented by the operating system, and the operating system may call a function implemented by the driver (106). Specifically, the driver (106) may issue a command to the peripheral electronic device. Once the peripheral electronic device sends the data back to the driver (106), the driver (106) may invoke routines in the calling application. Put another way, the driver (106) enables the peripheral electronic devices to communicate with the operating system. A driver (106) enables the operating system to ask the peripheral electronic devices to perform certain operations.

In this example, the driver (106) unpacks the data, i.e., it removes it from the transmission and in some examples may translate the data back into the native protocol. In an example, the driver (106) reverses the operations carried out by the configurable logic element (102). For example, the driver (106) may extract, (de-aggregate) the signals from the aggregated data transmission. For those signals encapsulated in their native format, the driver (106) may present these signals in their native format to the operating system. For those signals which were translated from their native format into the uniform transmission format, the driver (106) may present these signals in the uniform format to the operating system.

The driver (106) thereby represents the peripheral electronic devices to the operating system. That is, the present system not only packs and unpacks data, but also represents multiple peripheral electronic devices over the fewest number of interconnects and making the OS and application believe they are interfacing with the original peripheral electronic device, without being aware that such communication is not the native protocol.

Accordingly, the driver (106) may process the output of the peripheral electronic device and pass it to the operating system, such that the operating system may interact with the peripheral electronic device. For example, the driver (106) may present a thermal imager as a thermal imager to the operating system. In such an example, the operating system may be unaware of any encapsulation, translation, and/or aggregation of the signals. By unpacking the signal from the uniform data transmission and making it available to the operating system, the operating system may interface as intended with the particular peripheral electronic device. That is, the present computing device (100) increases the efficiency of peripheral electronic device communication without impacting the interface between the operating system and peripheral electronic device. That is, the present system may be implemented with existing operating systems without altering the existing operating systems to accommodate the encapsulation, translation, and/or aggregation.

In an example, the driver (106) may represent the peripheral electronic devices directly to the operating system. In another example, the peripheral electronic devices may not be directly accessible by the OS application. In this example another driver, for example a filter driver may take the decapsulated peripheral electronic device and represent it to the OS or application.

Accordingly, such a computing device (100) results in simplified wiring as each peripheral electronic device is not individually wired to the driver (106) but is rather routed through a single communication pathway (104). The use of the uniform transmission protocol, which has a greater bandwidth and transmission rate than the native protocols of the peripheral electronic devices, increases bandwidth capability. Aggregating signals reduces bandwidth usage, which may reduce a quantity of transmissions. Reducing the quantity and bandwidth usage draws less power from a battery and thus increases the battery life of the computing device.

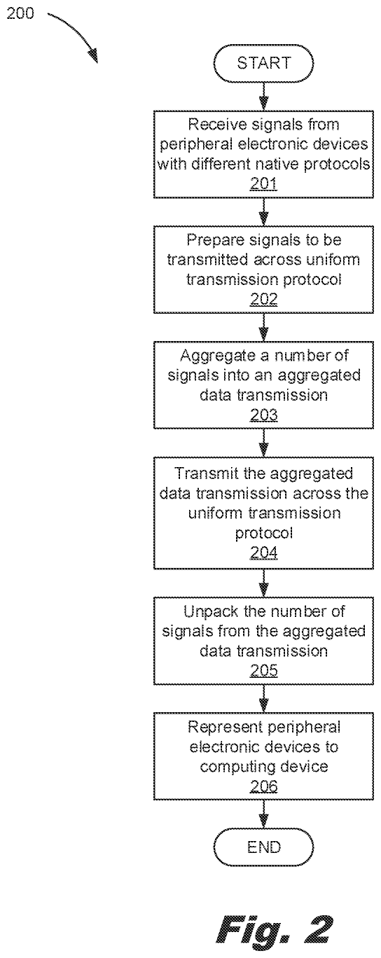

FIG. 2 is a flow chart of a method (200) for representing peripheral electronic devices via a uniform transmission protocol, according to an example of the principles described herein. According to the method (200), a number of signals are received (block 201) from a number of peripheral electronic devices. Specifically, the configurable logic element (FIG. 1, 102) receives the signals, which signals are sent using a native protocol. That is, each peripheral electronic device may implement any number of communication protocols such that the configurable logic element (FIG. 1, 102) may be coupled to peripheral electronic devices via any number of native protocols.

As described above, the configurable logic element (FIG. 1, 102) may prepare (block 202) the number of signals to be transmitted across a uniform transmission protocol. Such preparation (block 202) may include encapsulating a signal in its native protocol within the uniform transmission protocol. Such preparation may also include translating the signal from its native protocol into the uniform transmission protocol. As described different signals may be prepared (block 202) in different fashions. For example, a first signal may be encapsulated while a second signal may be translated. Accordingly, an aggregated data transmission may include both a translated signal and an encapsulated signal. Also as described above, a signal from a first peripheral electronic device may be encapsulated in one data transmission at one point in time and may be translated in another data transmission at another point in time.

Following either preparation (block 202) operation, i.e., encapsulation or translation, a number of signals are aggregated (block 203) into an aggregated data transmission and transmitted (block 204) via a communication pathway (FIG. 1, 104) using the uniform transmission protocol. As described above, the aggregated data transmission may include discrete data packets or a data stream. As an example of discrete packet transmission, at a given time ‘t’ all the data available is packaged into a single data packet that is transmitted at that time ‘t’ over the communication pathway (FIG. 1, 104). Accordingly, if there are a stream of signals or packets from the peripheral electronic devices, just those that are available to transmit at time ‘t’ will be put into the data transmission at that time. In another example, the aggregated data transmission may be a continuous flow of signals and packets, i.e., a stream.

A driver (FIG. 1, 106) of the computing device (FIG. 1, 100) unpacks (block 205) the number of signals from the aggregated data transmission allowing an operating system to access and process the signals. The driver (FIG. 1, 106) represents (block 206) the peripheral electronic devices to the computing device (FIG. 1, 106). As such, the operating system may interact with the peripheral electronic device, i.e., issue commands and receive data from the peripheral electronic device as expected, however, the information had been transmitted in a more resource and temporally efficient fashion via preparation (e.g., encapsulation and/or translation) and aggregation into a high speed, high throughput uniform transmission protocol such as PCIe or USB.

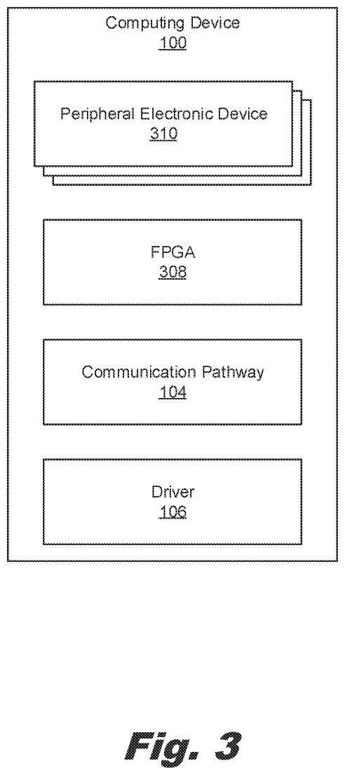

FIG. 3 is a block diagram of a computing device (100) for representing peripheral electronic devices via a uniform transmission protocol, according to an example of the principles described herein. In the example depicted in FIG. 3, the computing device (100) includes a number of peripheral electronic devices (310), with at least one peripheral electronic device (310) having a different native protocol relative to at least one other peripheral electronic device (310). As described above, while FIG. 3 depicts a number of peripheral electronic devices (310) on the computing device (100), the computing device (100) may also be coupled to peripheral electronic devices (310) that are separate from the computing device (100). These off-device peripheral electronic devices (310) may also have distinct native protocols and signals from such peripheral electronic devices (310) may be prepared and aggregated by the configurable logic element (FIG. 1, 102) for transmission across the uniform transmission protocol communication pathway (104).

In this specific example, the configurable logic element (FIG. 1, 102) is an FPGA (308) which includes hardware components that may be re-programed to carry out different functions. As described above, the FPGA (308) may perform at least one of encapsulation and translation of signals and may aggregate a number of signals into an aggregated data transmission to be communicated via a uniform transmission protocol.

In some examples, in addition to preparing and packaging signals with native protocols different than the uniform transmission protocol, the FPGA (308) may pass through a signal which has a native protocol that matches the uniform transmission protocol. That is, it may be that the native protocol for a peripheral electronic device (310) is a PCIe protocol or USB protocol to match that of the communication pathway (104). In this example, the FPGA (308) may bypass translation, encapsulation, and aggregation of this signal and may simply pass it through in its native protocol.

The computing device (100) also includes the communication pathway (104) and the driver (106) as described above. In an example, the driver (106) may alter the signal. For example, the driver (106) may act as a filter driver to filter the sensor signal prior to representation to the operating system. For example, a camera sensor stream may be presented to the driver (106) for access by the operating system. In this example, the driver (106) may process, filter, or manipulate the image data in some fashion. As a particular example, the driver (106) may detect faces in the image and thus present the camera to the operating system as if it is a face detection sensor. In other words, the driver (106) may present the camera as a camera, or may present it as a different sensor based on filtering, altering, or otherwise manipulating the camera output prior to presentation to the operating system. In an example, the drover (106) may not act as the filter driver, but rather feed the signal into a filter driver or another device that the OS or application may interface with.

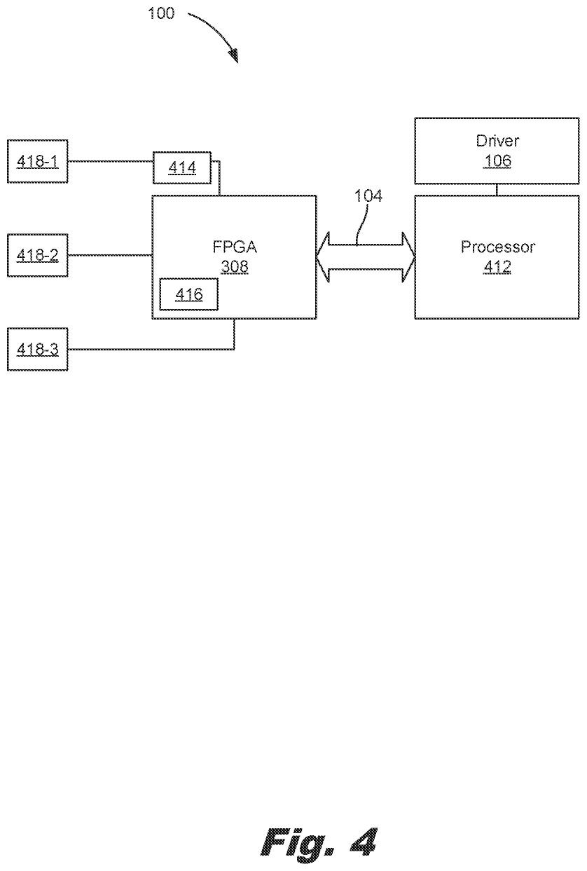

FIG. 4 is a diagram of a computing device (100) for representing peripheral electronic devices via a uniform transmission protocol, according to an example of the principles described herein. FIG. 4 clearly depicts the FPGA (308) and the driver (106) as described above. FIG. 4 also depicts the processor (412) of the computing device (100).

In some examples, the peripheral electronic device (FIG. 3, 310) may be just a physical sensor (418-1, 418-2, 418-3). For example, a peripheral electronic device (FIG. 3, 310) may be a physical camera located on or coupled to the computing device (100). In another example, the peripheral electronic device (FIG. 3, 310) may include a supplemental integrated circuit (414) to execute an operation on the signal from the sensor (418). That is, the supplemental integrated circuit (414) may filter or alter the signal output by the sensor (418). Such a combination of a sensor (418) and a supplemental integrated circuit (414) may be referred to as a virtual sensor. The combination of the physical sensor (418) and the supplemental integrated circuit (414) emulates a new sensor.

As a particular example, a first physical sensor (418-1) may be a camera to capture an image of a scene. The supplemental integrated circuit (414) may be a machine learning integrated circuit which analyzes the image to determine whether it contains a face of a person. As such, the virtual sensor is presented to the operating system as a facial recognition sensor. As such, the supplemental integrated circuit (414) may present different, and additional, sensors to the operating system than are physically coupled to the computing device (100).

In an example, the configurable logic element (FIG. 1, 102), (e.g., the FPGA (308)) may include, for at least one peripheral electronic device (FIG. 3, 310), a proxy register(s) (416) to mirror peripheral electronic device configuration information which is found on a register of the at least one peripheral electronic device (FIG. 3, 310). That is, each peripheral electronic device (FIG. 3, 310) may include a register with configuration information. In an example, the configuration information may include a model of a sensor (418). As a particular example for a camera sensor, the configuration information may include a resolution, a frame rate, instructions as to whether the camera should wake up the system based on motion, and a color scheme among other pieces of information. As another example, configuration information for an accelerometer may include a resolution or sampling rate. While particular reference is made to particular types of configuration information, other types of configuration information may be implemented in accordance with the principles described herein.

This configuration information is retrieved when initializing a particular peripheral electronic device (FIG. 3, 310) such that the operating system may know how to control and communicate with the peripheral electronic device (FIG. 3, 310). To collect the configuration information, the peripheral electronic device (FIG. 3, 310) may be woken up from a sleep state. Upon becoming active, the peripheral electronic device (FIG. 3, 310) may consume power, even though it is merely establishing a communication relationship and not yet transmitting any sensor output.

The proxy register (416) by mirroring the peripheral electronic device configuration information may conserve power as the peripheral electronic device (FIG. 3, 310) may be maintained in a sleep state while the operating system is establishing communication parameters. That is, the configurable logic element (FIG. 1, 102) may access the peripheral electronic device configuration information from the proxy register (416) while keeping the peripheral electronic device (FIG. 3, 310) in a sleep state. Once the configuration information is processed and acted upon, the configurable logic element (FIG. 1, 102) may wake the at least one peripheral electronic device (FIG. 3, 310) for data transmission. Accordingly, the peripheral electronic device (FIG. 3, 310) is kept in a sleep state for a longer period of time than it otherwise would as sensor setup is performed via the proxy register (416) while the peripheral electronic device (FIG. 3, 310) is asleep, thus conserving power and prolonging battery life of the computing device (100).

As described above, the configurable logic element (FIG. 1, 102), e.g., the FPGA (308), may package signals from peripheral electronic devices (FIG. 3, 310). The configurable logic element (FIG. 1, 102) may also unpackage command signals from an aggregated command transmission. That is, the driver (106) may aggregate command signals from a number of applications and transmit the aggregated command signals across the communication pathway (104). The configurable logic element (FIG. 1, 102) may unpackage the incoming command from an aggregated command transmission from the driver and may transmit the incoming command to a corresponding peripheral electronic device (FIG. 3, 310).

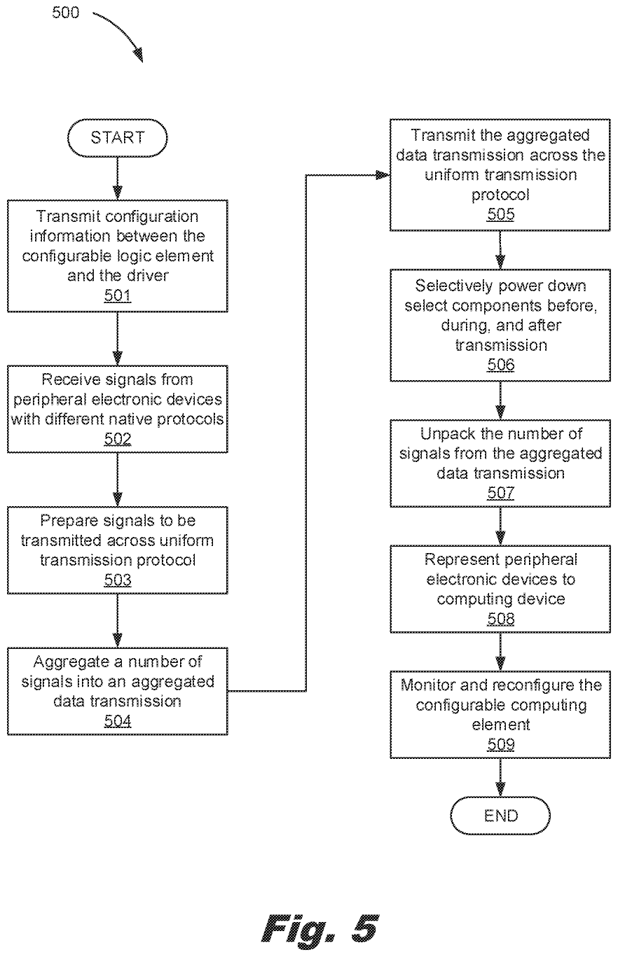

FIG. 5 is a flow chart of a method (500) for representing peripheral electronic devices via a uniform transmission protocol, according to an example of the principles described herein. According to the method (500), configuration information is transmitted (block 501) between the configurable logic element (FIG. 1, 102) and the driver (FIG. 1, 106). As described above, the configurable logic element (FIG. 1, 102) is coupled to a variety of peripheral electronic devices (FIG. 3, 310) and has a variety of ways in which it can prepare the signals for transmission to the driver (FIG. 1, 106). Accordingly, the communication configuration information transmitted (block 501) may identify which peripheral electronic devices (FIG. 3, 310) are going to be transmitting data and the format (e.g., encapsulation or translation) of the signal preparation, etc. Other examples of this communication configuration information includes whether the data needs to be buffered and a time frame over which the data may be aggregated into a packet. While particular reference is made to certain types of communication configuration information, other types of communication configuration information may be implemented in accordance with the principles described herein.

According to the method (500), signals are received (block 502) from the different peripheral electronic devices (FIG. 3, 310), each according to its own particular native protocol. The signals are prepared (block 503) (i.e., encapsulated and/or translated) and aggregated (block 504) into an aggregated data transmission. These operations may be performed as described above in connection with FIG. 2.

As described above, the aggregated data transmission is transmitted (block 505) across the uniform transmission protocol. In some examples, during, before, or after transmission, the communication pathway (FIG. 1, 104) and/or different peripheral electronic devices (FIG. 3, 310) are selectively powered down (block 506), when inactive. In so doing, the communication pathway (FIG. 1, 104) and/or peripheral electronic devices (FIG. 3, 310) may be kept in a lower power state, unless there is data to transmit. That is, whenever a communication pathway (FIG. 1, 104) or peripheral electronic device (FIG. 3, 310) is active, it consumes power. Selectively powering down (block 506) these components reduces the duty cycle and may therefore conserve power. There are a variety of examples of how the components may be selectively powered down (block 506).

In one particular example, a peripheral electronic device (FIG. 3, 310) may be powered down until it has data to transmit. Keeping the peripheral electronic device (FIG. 3, 310) in an inactive state until the operating system activates the peripheral electronic device (FIG. 3, 310) conserves power and elongates the battery life of the computing device (FIG. 1, 100).

As another example, if the operating system is not requesting any data from any of the peripheral electronic devices (FIG. 3, 310), the entire communication pathway (FIG. 1, 100) and/or the configurable logic element (FIG. 1, 102) may be placed in a sleep state again to conserve power.

In yet another example, the configurable logic element (FIG. 1, 1020) may transmit data at a higher rate than a peripheral electronic device (FIG. 3, 310) captures data. Accordingly, the communication pathway (FIG. 1, 104) may be deactivated for a certain number of cycles. That is, the transmissions from a peripheral electronic device (FIG. 3, 310) may be intermittent depending on the data rate required for a specific peripheral electronic device (FIG. 3, 310). For example, an I2C peripheral electronic device (FIG. 3, 310) may transmit data over multiple cycles. However, that same data may be transmitted over the PCIe communication pathway (FIG. 1, 104) over a single clock cycle. Furthermore, based on the data rate required, more cycles from the sensor/chips could be buffered and delivered over one or fewer cycles on the PCIe/USB communication pathway (FIG. 1, 104).

As a particular example, a camera sensor (FIG. 3, 310) may transmit data at a rate of 30 frames per second. In this example, the PCIe communication pathway (FIG. 1, 104) may operate at a different rate. Accordingly, the FPGA (FIG. 3, 308) may collect 2 or 3 frames of data and send them in one transmission to the driver (FIG. 1, 106). The driver (FIG. 1, 106) may then parse them out to the operating system at the 30 frame per second. In so doing, rather than being active for each cycle, the communication pathway (FIG. 1, 104) is active for a subset of the cycles, thus reducing the activity of the communication pathway (FIG. 1, 104) which conserves power and elongate the battery life of the computing device (FIG. 1, 104).

In another example, the transmissions along the communication pathway (FIG. 1, 104) may be gated to a certain rate. For example, unless instructed otherwise by the operating system, the communication pathway (FIG. 1, 104) may allow a transmission at a given periodic interval and any data collected within the periodic interval is collected and held until the interval expires, at which point it is transmitted. Using these methods, the quantity of transmissions is reduced, the bandwidth usage more efficient, and the power consumed on the communication pathway (FIG. 1, 104) is reduced.

As described above, the driver (FIG. 1, 106) unpacks (block 507) the number of signals such that they may be accessed by the operating system. As described above, such unpacking may include extracting the separate signals out of the aggregated data transmission. When unpackaged, the operating system may access and process the data.

As such, the driver (FIG. 1, 106) represents (508) the peripheral electronic devices (FIG. 3, 310) to the computing device (FIG. 1, 100) such that the computing device (FIG. 1, 100) and components thereof may interact with the peripheral electronic devices (FIG. 3, 310) as intended.

In some examples, the configurable logic element (FIG. 1, 102) may be monitored reconfigured (block 509) responsive to a change in a peripheral electronic device (FIG. 3, 310) coupled thereto. That is, as described above, an FPGA (FIG. 3, 308) may be reconfigured through program code instructions. Accordingly, if a change to a peripheral electronic device (FIG. 3, 310) is made, the FPGA (FIG. 3, 308) may be reprogrammed to accommodate that change. In some examples, the change may be the addition of a new sensor, or an update to an existing sensor. The update or new sensor may have new features that triggers an update to the FPGA (FIG. 3, 308) to support the new features or new sensor.

As described above, the prepared and packaged transmissions may be bi-directional. In this example, the configurable logic element (FIG. 1, 102) may receive an aggregated command transmission and unpackage the aggregated command transmission.

Such systems and methods 1) reduce the wire count in a computing device, in particular through constrained zones such as through a hinge and around a motherboard; 2) increase the throughput of transmissions between the operating system and the peripheral electronic devices; 3) reduce the transmission count by aggregating signals; 4) are scalable as the configurable logic element may be re-configured when new peripheral electronic devices are added; 5) reduce power consumption via duty cycling to improve battery life; 6) are robust against developments in sensor technology and development of new sensors; and 7) allow for a reduction in the physical size of a computer, for example by reducing a hinge based on the reduced wire count. In other words, the present devices and methods simplify the entire connection and provide a higher speed, higher bandwidth, and robust aggregation connection to the operating system of various sensors. However, it is contemplated that the systems and methods disclosed herein may address other matters and deficiencies in a number of technical areas.

What is claimed is:

1. A computing device, comprising:
a configurable logic element to:
connect to a number of peripheral electronic devices, at least one peripheral electronic device having a different native protocol relative to another peripheral electronic device; and
prepare and package a number of signals to be transmitted across a uniform transmission protocol;
a communication pathway to transmit packaged signals to a driver using the uniform transmission protocol; and
the driver to:
unpack the number of signals from the aggregated data transmission; and
represent the number of peripheral electronic devices to an operating system of the computing device.

2. The computing device of claim 1, wherein:
the configurable logic element comprises multiple devices; and
each device is to execute a sub-operation of preparing and packaging of the number of signals.

3. The computing device of claim 1, wherein the uniform transmission protocol is selected from the group consisting of:
a peripheral component interconnect express (PCIe) protocol; and
a universal serial bus (USB) protocol.

4. The computing device of claim 1, wherein the peripheral electronic device comprises:
a sensor; and
a supplemental integrated circuit to execute an operation on a sensor output.

5. The computing device of claim 1, wherein:
the configurable logic element comprises, for at least one peripheral electronic device, at least one proxy register to mirror peripheral electronic device configuration information which is found on a register of the at least one peripheral electronic device;
the configurable logic element is to access the peripheral electronic device configuration information from the proxy register while the at least one peripheral electronic device is asleep; and
responsive to accessing and processing the configuration information, the configurable logic element is to wake the at least one peripheral electronic device for data transmission.

6. The computing device of claim 1, wherein the configurable logic element is to:
unpackage an incoming command from the driver; and
transmit the incoming command to a corresponding peripheral electronic device.

7. A method, comprising:
at a configurable logic element:
receiving a number of signals from a number of peripheral electronic devices, at least one peripheral electronic device having a different native protocol relative to at least one other peripheral electronic device;
preparing the number of signals to be transmitted across a uniform transmission protocol; and
aggregating the number of signals into an aggregated data stream;
transmitting, via a communication pathway, the aggregated data transmission using the uniform transmission protocol;
unpacking, at a driver, the number of signals from the aggregated data transmission; and
representing the number of peripheral electronic devices to an operating system of a computing device.

8. The method of claim 7, wherein preparing the number of signals comprises at least one of:
encapsulating the number of signals in their native protocol within the uniform transmission protocol; and
translating the number of signals from their native protocol into the uniform transmission protocol.

9. The method of claim 7, further comprising:
receiving an aggregated command transmission; and
unpackaging the aggregated command transmission.

10. The method of claim 7, further comprising transmitting configuration information between the configurable logic element and the driver.

11. The method of claim 7, further comprising selectively powering down at least one of the communication pathway and peripheral electronic devices when inactive.

12. The method of claim 7, further comprising reconfiguring the configurable logic element responsive to a change to at least one peripheral electronic device.

13. A computing device comprising:
a number of peripheral electronic devices, at least one peripheral electronic device having a different native protocol relative to at least one other peripheral electronic device;
a field programmable gate array (FPGA) to package signals from the number of peripheral electronic devices by:
performing at least one of encapsulation and translation of signals; and
aggregating a number of signals into an aggregated data transmission to be communicated via a uniform transmission protocol;
a communication pathway to transmit the aggregated data transmission to a driver using the uniform transmission protocol; and
the driver to:
unpack the number of signals from the aggregated data transmission; and
represent the number of peripheral electronic devices to an operating system of the computing device.

14. The computing device of claim 13, wherein packaging a signal comprises passing through a signal which has a native protocol to match the uniform transmission protocol.

15. The computing device of claim 13, wherein the aggregated data transmission comprises both:
a translated signal; and
an encapsulated signal.
